(19) United States
(12) Patent Application Publication
(10) Pub. No.: US 2026/0336572 A1
(43) Pub. Date: Oct. 29, 2026

(54) BEAM CIRCUMFERENTIAL EXTENSION ARM FOR INCREASED OPERATIONAL RANGE

(71) Applicant: Motor City Wash Works, Inc., Wixom, MI (US)

(72) Inventors: Doug Calvin, Livonia, MI (US); Michel LeCourt, Westland, MI (US); Andrew Marcinak, Ferndale, MI (US)

(73) Assignee: Motor City Wash Works, Inc., Wixom, MI (US)

(21) Appl. No.: 19/658,772

(22) Filed: Apr. 27, 2026

Related U.S. Application Data
(60) Provisional application No. 63/795,028, filed on Apr. 25, 2025.

(51) Int. Cl. B60S 3/06

(52) U.S. Cl. CPC B60S 3/06

(57) ABSTRACT

A vehicle wash apparatus includes an arm mounted to a vertical beam such that a proximal portion extends around the beam and is positioned outside a tunnel defined by opposing beam sets. A distal portion of the arm supports a tool configured to be selectively extended into the tunnel. An actuator moves the tool between retracted and extended positions. The configuration increases the usable operational width of the tunnel without modifying beam spacing, enabling improved compatibility with wider vehicles and retrofit installation in existing systems.

### CROSS-REFERENCE TO RELATED APPLICATIONS

This application is a Non-Provisional Patent Application, which claims the benefit of U.S. Provisional Patent Application 63/795,028, filed Apr. 25, 2025, the entire contents of which are incorporated herein by reference.

### TECHNICAL FIELD

The present disclosure relates to automated vehicle carwash systems and, more particularly, to beam-mounted actuation arms configured to extend from behind structural beams to increase usable wash space within fixed-width tunnels.

### BACKGROUND

Conventional tunnel carwash systems rely on structural vertical beams arranged in parallel rows to support wash equipment. In many legacy installations, the spacing between opposing beam rows is fixed and relatively narrow, reflecting earlier vehicle size assumptions. This structural constraint creates multiple technical limitations. These limitations include: reduced clearance for modern vehicles, including trucks and wide-body vehicles; interference between wash tools and vehicles, increasing risk of damage; limited retrofitting capability, since moving structural beams is cost-prohibitive; and inefficient tool positioning, where tools must be mounted forward of beams, consuming valuable interior tunnel space.

Existing extension arms, including those referenced in the cited prior art, generally mount on the front or interior-facing side of the beam, thereby further reducing usable space. Accordingly, there is a need for a system that increases the functional wash envelope without relocating beams and that allows tools to enter the tunnel only when needed, while remaining outside the constrained space.

In addition, vehicles have changed over time, including in size. Further, more people are driving trucks, which have a wider wheelbase. Many traditional carwashes lack proper accommodations for wide vehicles, which can result in damage to the vehicle and/or the carwash equipment. There is also a need to retrofit older carwash systems to allow for accommodating larger vehicles, including wider vehicles.

For example, known structures used in a carwash can be found in U.S. Patent Nos. 7,753,326, 7,784,756, and 8,512,835, which are fully incorporated herein by reference. However, there are opportunities to further improve such structures, including extending the reach of car wash tools for larger vehicles.

Therefore, there are multiple opportunities to improve the structures of carwash cleaning systems, including a curved-arm apparatus that addresses the limitations and disadvantages of current car wash systems.

### SUMMARY

The invention provides a rear-mounted, beam-circumventing extension arm that enables wash tools to be deployed into a carwash tunnel from behind the structural beams, rather than from the front-facing interior. The arm includes a curved proximal portion that wraps around the beam, allowing the arm to: mount externally (rear side of beam); extend forward into the tunnel space; avoid occupying interior clearance when retracted.

Advantages include:
1. Expansion of functional tunnel width (without structural modification): The system effectively increases usable space between opposing beams by relocating the arm’s mounting origin outside the tunnel envelope.
2. Retrofit compatibility with legacy systems: Older systems with narrow beam spacing can be upgraded without relocating beams or altering structural supports.
3. Dynamic envelope control – through actuation, tools: Retract behind or adjacent to the beam, thus allowing wide vehicles to pass and extend into the tunnel, thus enabling effective cleaning of narrower vehicles.
4. Reduced collision risk: Because tools originate from behind the beam and enter only when needed, interference zones are minimized.
5. Improved Tool Reach and Geometry – the curved geometry enables: Forward projection into optimal cleaning positions; and more favorable approach angles (e.g., for wheels as shown in FIG. 2A).

As used herein, “beam-bypassing geometry” refers to an arm configuration in which the structural mounting origin is positioned outside the tunnel while the arm extends around the beam to project into the tunnel.

In one general aspect, a curved arm apparatus may include an arm having a proximal end and a distal end, the arm having: a curved portion at the proximal end, the curved portion being a structural member configured to extend around at least a portion of a vertical beam of the series of vertical beams, the curved portion having an arcuate profile and configured to attach to the outside face of the vertical beam; a straight portion extending from the curved portion to the distal end, the straight portion being a structural member extending longitudinally from the curved portion and configured to connect to the tool. The curved arm apparatus may also include a tool coupled to the distal end of the arm. The curved arm apparatus may furthermore include a mounting mechanism configured to mount the arm on the outside face of the vertical beam such that the curved portion extends around the vertical beam. The apparatus may, in addition, include an actuator configured to move the arm between a first position holding the tool closer to the vertical beam and a second position holding the tool deeper into the tunnel in relation to the vertical beam.

In another aspect of the disclosure, a vehicle treatment apparatus for use in a tunnel defined by opposing sets of vertical beams, including an arm having a proximal end and a distal end. The proximal end includes a curved portion configured to extend at least partially around a vertical beam such that at least a portion of the arm is positioned on a side of the vertical beam opposite the tunnel. The apparatus includes a distal portion extending from the curved portion and configured to project into the tunnel; a tool coupled to the distal end; and an actuator configured to move the arm between: (i) a retracted position in which the tool is positioned outside or adjacent to the vertical beam, and (ii) an extended position in which the tool is positioned within the tunnel to engage a vehicle. The apparatus can include a curved portion with at least a partial arcuate profile configured to distribute load around the beam. The apparatus can include an arm mounted entirely on the exterior-facing side of the beam. The apparatus can include an actuator that includes a pivot located behind the beam relative to the tunnel.

The apparatus can include a tool that comprises a rotating brush.

The apparatus can include a retracted position that places the tool outside a maximum vehicle envelope.

The apparatus can include a curved portion that wraps around at least 90 degrees of the beam.

In another aspect of the disclosure, a vehicle wash system includes a first set of vertical beams and a second set of vertical beams defining a tunnel; at least one arm mounted to a beam of the first set, the arm including a curved portion extending around the beam to position a mounting portion outside the tunnel; a tool supported by the arm; and an actuator configured to move the tool between a retracted position and an extended position within the tunnel. The system includes a method for increasing the functional usable width of the tunnel without increasing spacing between the sets of vertical beams. The system of can further include a second arm mounted to an opposing beam and supporting the tool. The system can include where the arms are synchronized. The system can include where the arm is configured for retrofit installation on an existing carwash structure.

In another aspect of the disclosure, a method of operating a vehicle wash system, includes providing an arm rotatably associated with a vertical beam such that a portion of the arm is positioned outside a tunnel defined by the beams. The method includes retracting a tool to a position adjacent to or behind the beam and extending the tool into the tunnel to engage a vehicle. The method increases usable operational width without modifying beam spacing.

### BRIEF DESCRIPTION OF THE DRAWINGS

Advantages of the present disclosure will be readily appreciated as the same becomes better understood by reference to the following detailed description when considered in connection with the accompanying drawings wherein:

FIGS. 1A-1D provide a perspective view, a cross-sectional perspective view, a top view, and a wire-frame perspective view, respectively, of the curved arm apparatus, as described herein;

FIGS. 2A-2C are a front perspective view, a first rear perspective view, and a second rear perspective view of a system of two curved arm apparatuses, as described herein; and

FIGS. 3A-3C are top-down views of two curved arm apparatuses working together to move a tool from a retracted position to an extended position, as described herein.

### DETAILED DESCRIPTION

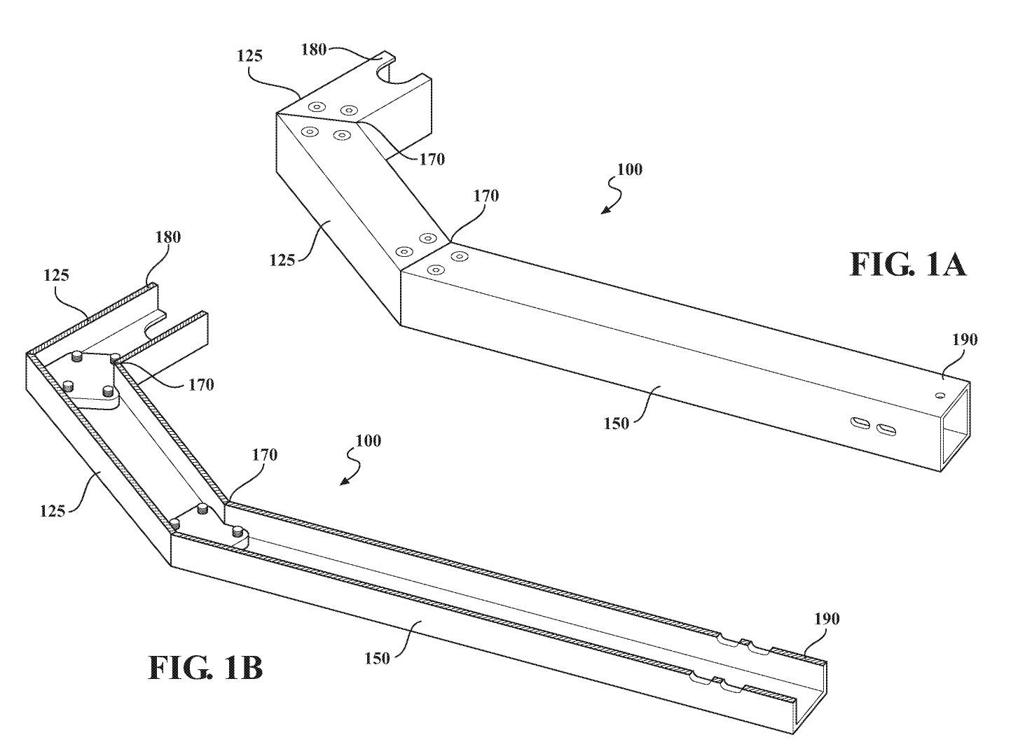

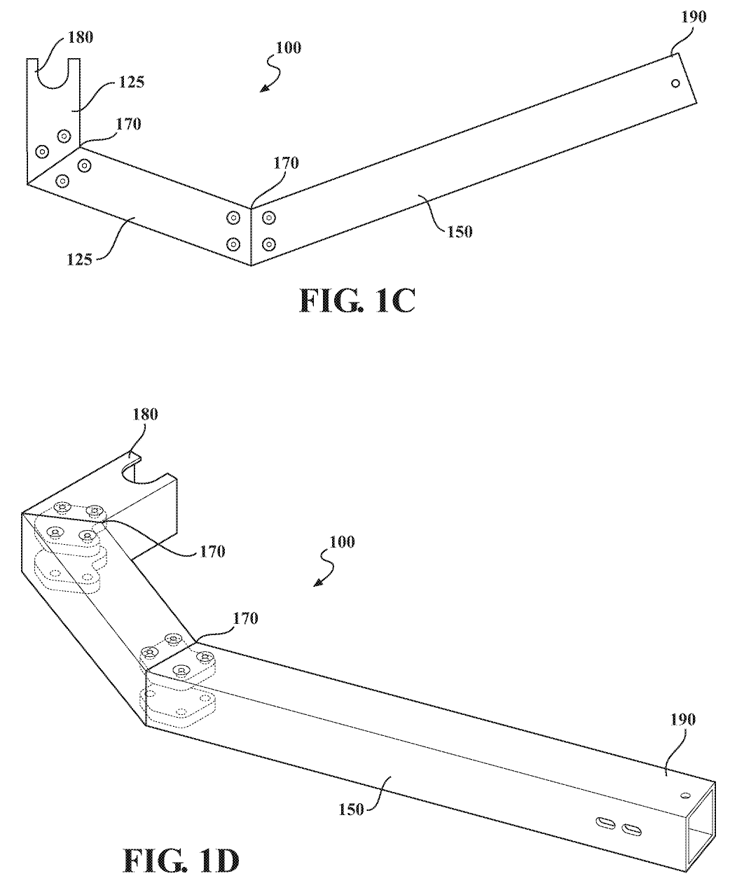

With reference to FIGS. 1A–1D, a curved arm apparatus 100 comprises a curved portion 125 and a straight portion 150. The curved arm apparatus 100 includes a pivoting end 180 defining a rotational joint and a distal end 190 configured to support a tool being actuated. The curved portion 125 is configured to extend around or wrap around at least a portion of a vertical beam. The curved arm apparatus 100 may be formed from straight tubular steel, with joints 170 used to create the curve of the curved portion 125. The use of other suitable materials to form the curved arm apparatus 100 is contemplated within the scope of the disclosure, including but not limited to stainless steel, carbon fiber, and various plastics or like materials known to those of skill in the art. The curved arm apparatus 100, pivoting end 180, is adapted to allow for pivoting. The tool-actuating end 190 is adapted to connect to and actuate a tool, such as a rotating cleaning roller in a carwash system.

In the figures, the curved arm apparatus 100 is shown with the curved portion 125 and the straight portion 150 as linear components connected together with nuts and bolts. It should be understood that the curved arm apparatus 100 could be formed in many ways known to a person of skill in the art, including a single piece of material that is bent to form the prescribed curvature or a pre-formed arm apparatus including the prescribed curvature.

In embodiments, as shown in FIGS. 1A–1D, the arm 100 includes a curved portion 125 at the proximal end, a straight portion 150 extending to the distal end 190. The curved portion wraps partially around the beam, positions the pivot, and forms the structural load path behind the beam. This configuration creates a beam-bypassing geometry, allowing the arm to “reach around” the beam rather than projecting from its interior face. This is an advantage because the tool being actuated by the arm also takes up space in the carwash tunnel. By having the arm reach around the beam, a substantial amount of space is made available within the tunnel width.

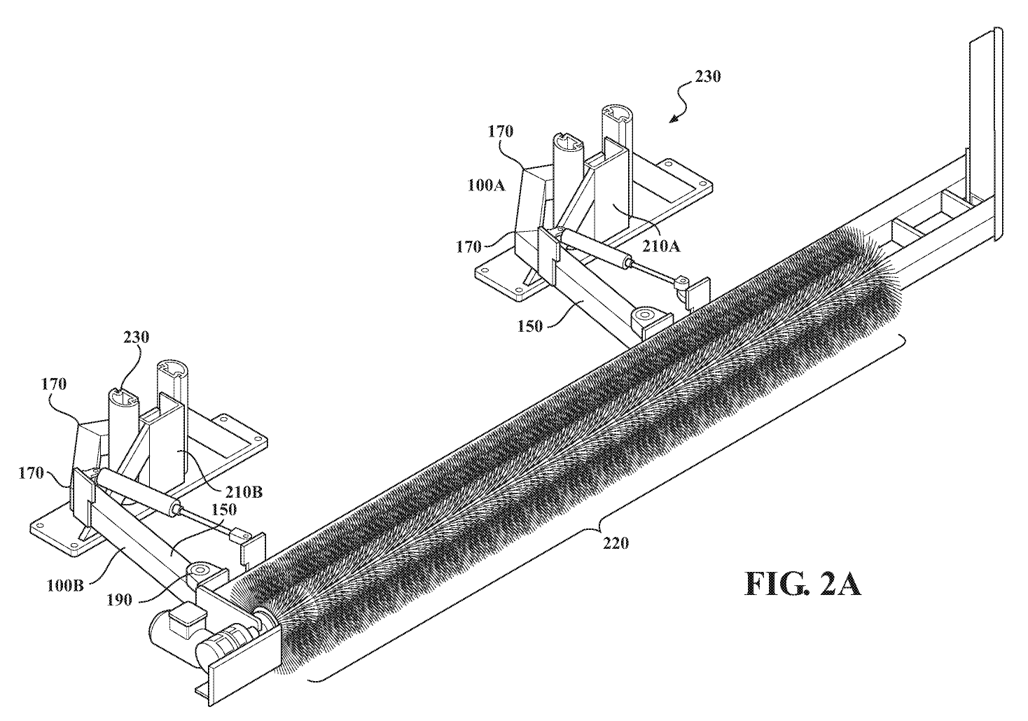

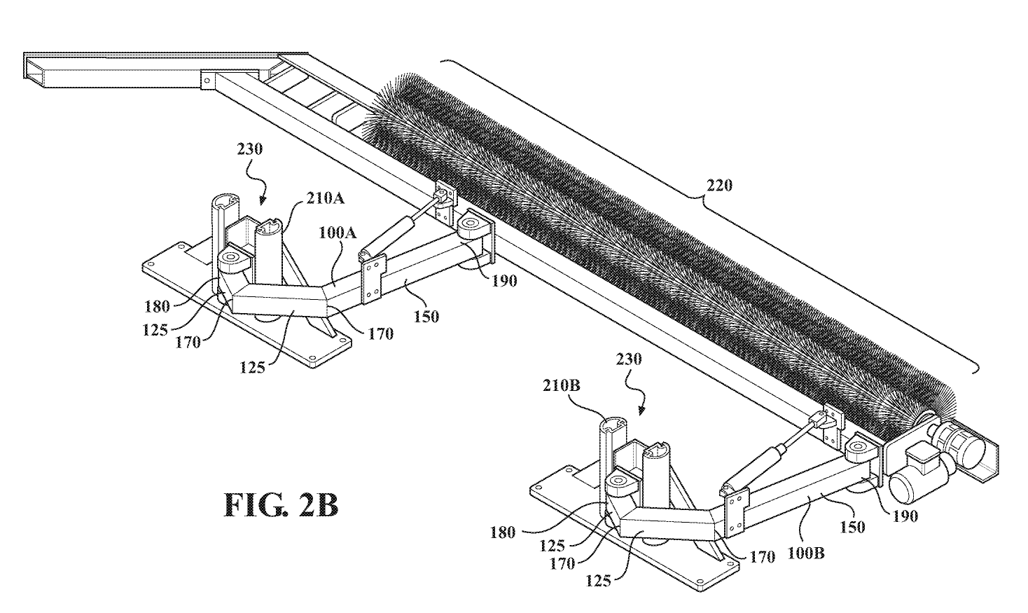

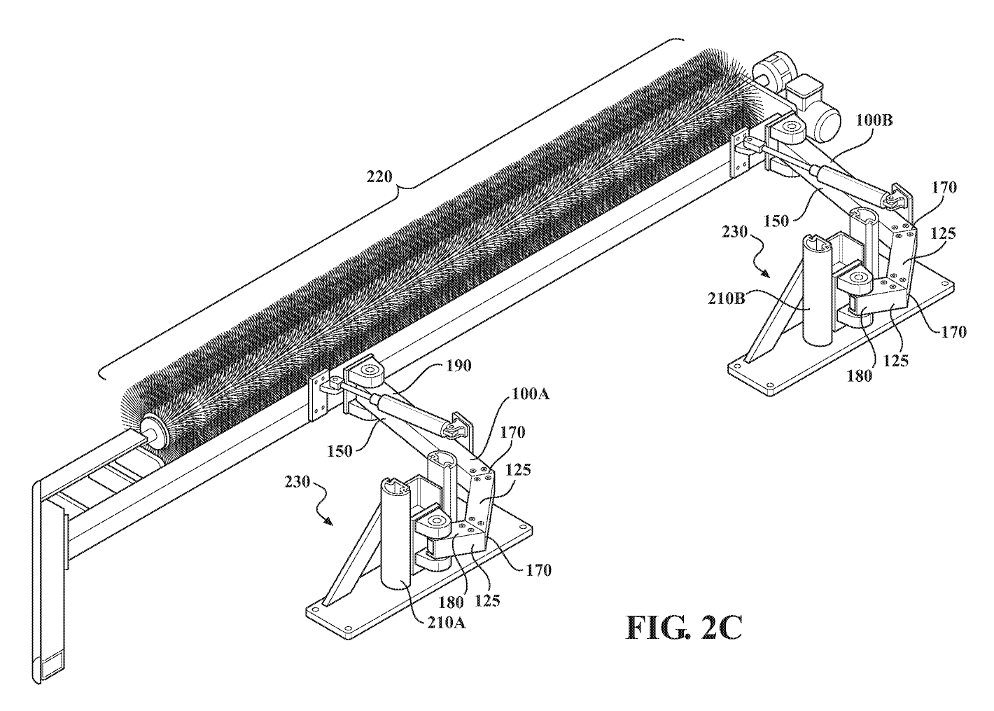

Referring to FIGS. 2A–2C, a carwash extension system 200 includes a first and second sets of vertical beams 210A, 210B defining a tunnel, one or more extension arm assemblies 100A, 100B, and a tool 220. A first curved arm apparatus 100A may be used in parallel with a second curved arm apparatus 100B, the two arms supporting a common tool 220 via their distal ends 190. In some embodiments, an actuator drives rotation about the pivoting end 180, causing the straight portion 150 to move outwardly. The actuator responsible for pivoting the extension arm assemblies 100A, 100B, is well known to those of skill in the art.

Each arm assembly is mounted on an exterior-facing side of a respective beam, such that the arm at least in part originates outside the tunnel envelope. Although the beams (210A, 210B) are seen as truncated in length for the purpose of focusing on the extension arm assemblies (100A, 100B), it should be appreciated that the beams could project about three (3) or more meters upward and be interconnected with other beams both along the path of a carwash tunnel and from one side of the tunnel to the other, as may be present in existing carwashes.

In additional embodiments, the curved arm apparatus 100A, 100B is configured to facilitate the application of various tools to vehicles as they traverse through a structured tunnel (not shown), such as a carwash system comprising washers, rollers, and dryers. This tunnel may include a series of vertical beams 210A, 210B arranged in two parallel lines. In this application, there are two curved arm apparatuses 100A, 100B. In this embodiment, the curved portion 125, located at the proximal end of the arm, is engineered to wrap around a segment of the vertical beam 210A, 210B, effectively securing the arm to the tunnel's structure. The curved portion 125 comprises a partial arcuate profile that allows it to attach to the external face of the vertical beam 210, thereby ensuring stability and support for the entire system.

In some embodiments, extending from the curved portion 125 is the straight portion 150 of the arm, which reaches out to the distal end 190 where a tool may be attached. This straight portion may serve as a crucial structural member, providing the necessary length and rigidity to connect the tool to the arm. The tool may be coupled to the distal end 190, poised to perform its designated function on the vehicle as it progresses through the tunnel. This design allows for seamless integration of the tool with the arm, ensuring that the tool can be precisely maneuvered to perform its intended task. In some embodiments, a car wash tool includes one or more of soft cloth brushes, rotating brushes, foam brushes/applicators, high-pressure water sprayers, chemical applicators, miter curtains, tire and wheel cleaners, high-velocity air blowers, soft cloth/chamois dryers, and the like.

In embodiments, the curved arm apparatus 100 comprises a mounting mechanism 230 configured to secure the curved arm apparatus 100A, 100B to the vertical beam. The mounting mechanism 230 can take any of several forms well known to someone of skill in the art. It should be noted that a corresponding set of vertical beams can be located opposite the first set, thus creating the tunnel through which vehicles travel. In this arrangement, there is typically a fixed amount of space between the two sets of beams. This creates limitations for vehicles traveling through the tunnel, especially when the tunnel includes car washing equipment, such as rollers that are actuating from the sides of the tunnel. For example, wider vehicles will have difficulty traversing through a narrow tunnel created by the two opposite sets of beams. This is especially true for older car-washing systems with limited space in the tunnel. An advantage of the disclosure, including the curved arm apparatus, is that it allows for creating a wider functional space between the two sets of beams without moving one or both sets of beams apart from each other.

This mechanism ensures that the curved portion 125 of the curved arm apparatus 100 maintains its position around the beam, providing a reliable anchor point that supports the operation of the curved arm apparatus 100. The mounting mechanism is used to maintain the alignment and stability of the arm, allowing it to function effectively without risk of detachment or misalignment during operation.

In some embodiments, to enhance the functionality of the curved arm apparatus, an actuator may be incorporated into the design. The actuator may move the curved arm apparatus 100A, 100B between two distinct positions. In the first position, the tool is held closer to the vertical beam 210A, 210B, allowing for operations that allow a wider vehicle to traverse the tunnel. In the second position, the tool is extended deeper into the tunnel, allowing for the cleaning of narrower vehicles as they pass through the tunnel. This dynamic movement capability afforded by the actuator may allow the tool to be positioned optimally for various tasks, enhancing the versatility and effectiveness of the car wash system in various applications. The actuator can be any of the available actuators, particularly suitable for carwash applications, as known to those of skill in the art.

With continuing reference to FIGS. 2A-2C, a first curved arm apparatus 100A may be used in parallel with a second curved arm apparatus 100B attached to the straight portion of both arms to form the extension system 200. In some embodiments, the extension system 200 may comprise two or more curved arm apparatuses (100A and 100B), each attached to separate vertical beams (210A and 210B), designed to operate in parallel and jointly extend a tool 220 from a retracted position to an extended position. In some embodiments, the curved arm apparatus 100 features a proximal curved portion that is structurally designed to wrap around a section of its respective vertical support beam, ensuring secure attachment. In some embodiments, the curved portion of each arm has an arcuate profile, allowing them to fit around the outer face of the vertical beams (210A and 210B), thereby providing stability and support for the arm’s operation. In some embodiments, extending from the curved portion may be a straight section that reaches outward to a distal end where the tool is mounted. In some embodiments, the curved arm apparatuses (100A and 100B) effectively extend the tool 220 into the desired position within the tunnel formed by the series of vertical beams and lateral struts.

In some embodiments, the operation of these two curved arm apparatuses (100A and 100B) may be synchronized, requiring them to work in tandem to move the tool 220 from a retracted position, closer to the vertical beams, to an extended position, deeper into the tunnel structure. In some embodiments, this movement may be facilitated by actuators connected to each arm, which are responsible for precisely controlling the arm's positioning. The actuators may enable the arms to pivot around their mounting points on the vertical beams, allowing the tool to be deployed into the tunnel as needed. The coordinated action of both arms ensures that the tool 220 is positioned accurately and efficiently within the tunnel, taking advantage of the structural support provided by the parallel arrangement of the vertical beams (210A and 210B) and their connecting struts. This setup may be beneficial for applications involving vehicles of varying widths moving through the tunnel, as it allows for seamless interaction between the tool and the vehicle, leveraging the stability and reach provided by the dual-arm configuration.

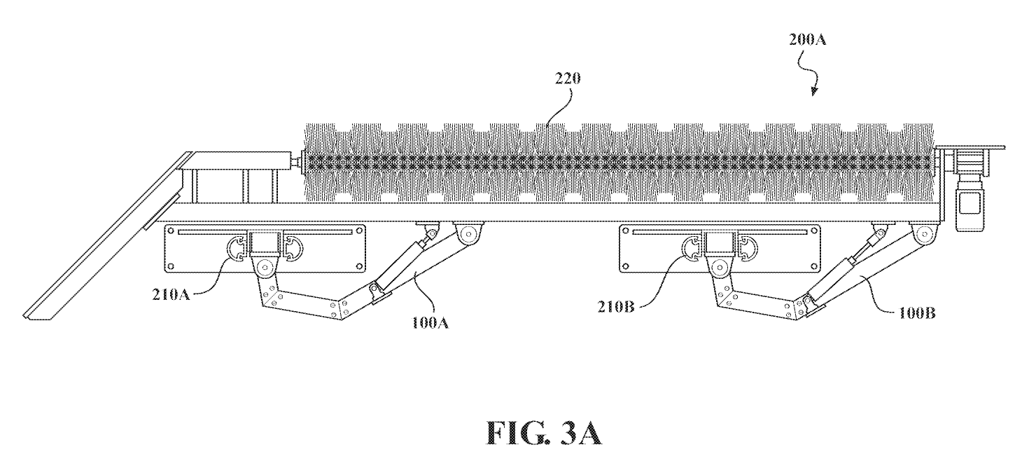

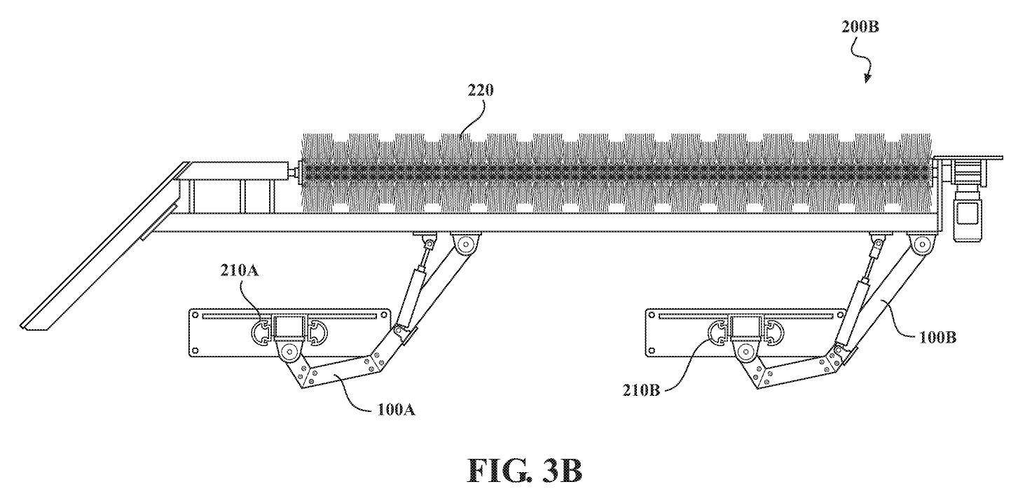

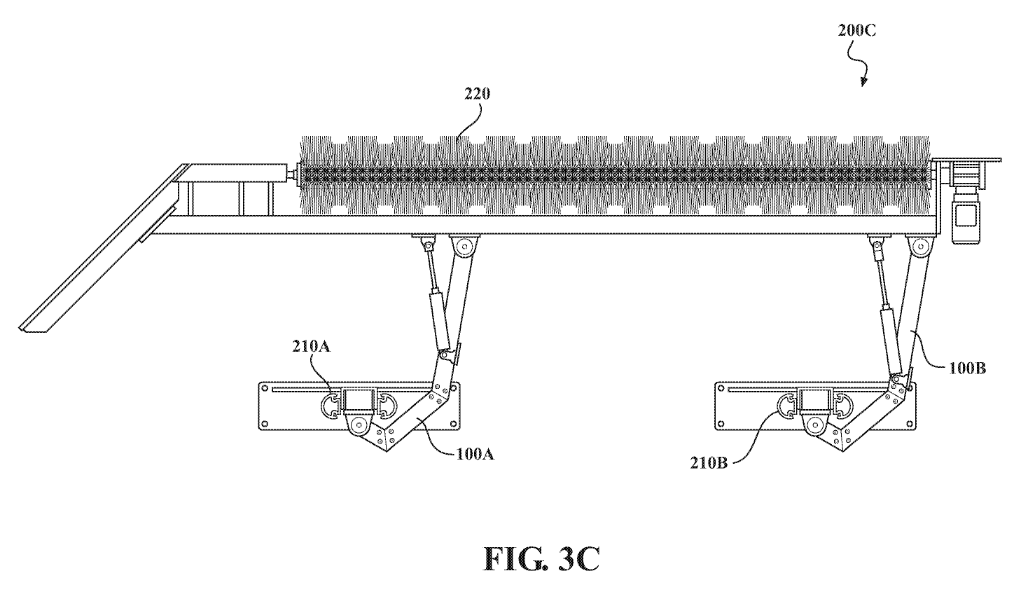

With reference to FIGS. 3A-3C, the extension system 200A, 200B, 200C may operate to move from a retracted position to an extended position. FIG. 3A shows an example embodiment of the extension system 200A in a retracted position. FIG. 3B shows an example embodiment of the extension system 200B in a midway position between being retracted and extended. FIG. 3C shows an example embodiment of the extension system 200C in an extended position.

Further, in embodiments, as illustrated in FIGS. 3A–3C, the arm moves between a retracted position, where the tool is near or behind the beam, to an intermediate position and then an extended position, where the tool is deployed into the tunnel. Advantageously, the retracted position preserves maximum tunnel clearance, effectively increasing usable width for wide vehicles.

In some embodiments (FIGS. 2A–2C), it is contemplated that two arms (100A, 100B) support a common tool 220. The arms actuate synchronously to maintain tool alignment, control lateral positioning, and stabilize the tool during its operational cycle. This configuration allows precise tool deployment without encroaching on static beam spacing constraints.

The method of operating the actuators of the curved arm apparatuses (100A and 100B) to operate the extension system 200 involves several coordinated steps. Initially, the actuators may be activated to pivot the curved arm apparatuses (100A and 100B) around their respective mounting points on the vertical beams (210A and 210B). As the actuators engage, the proximal curved portions of each arm, which are designed to wrap securely around the vertical beams, may begin to rotate. This rotation causes the straight sections of the arms to move outward, transitioning the tool 220 from its retracted position near the beams to an extended position deeper within the tunnel structure. The arcuate profile of the curved portions enhances stability and support throughout this movement, preventing any lateral displacement. As the arms extend, the tool is guided precisely along the path defined by the tunnel's vertical beams, ensuring accurate positioning. The synchronized operation of the actuators ensures that both arms move in unison, maintaining the tool’s alignment and stability. This coordinated action is crucial for applications involving vehicles of varying widths, as it allows the tool to interact seamlessly with the vehicle, leveraging the structural support and reach provided by the dual-arm configuration.

A first step of a method of using the extension system 200A, 200B, 200C may begin in the retracted position, as shown in FIG. 3A. The first curved arm apparatus 100A and the second curved arm apparatus 100B are positioned parallel to each other. The tool 220 is positioned close to the vertical beams 210A and 210B, minimizing the extension.

In a second step, the curved arm apparatuses 100A and 100B may pivot outwardly from the vertical beams 210A and 210B. The curved portions 125 of each arm apparatus begin to extend, causing the straight portions 150 to move outward. The tool 220 is partially extended from its initial retracted position, moving towards the middle position.

In a third step, the curved arm apparatuses 100A and 100B may pivot until they reach the fully extended position as shown in FIG. 3C. The straight portions 150 of each arm are now fully extended, maximizing the distance between the tool 220 and the vertical beams 210A and 210B. The tool 220 reaches its final extended position, allowing for optimal functionality as designed.

As described, unlike conventional systems, the structural mounting origin is displaced outside the tunnel. The tool enters the tunnel only when required. The system decouples structural beam spacing from the functional wash width.

Several embodiments have been discussed in the foregoing description. However, the embodiments discussed herein are not intended to be exhaustive or limit the invention to any particular form. All the embodiments are non-limiting embodiments. The terminology which has been used is intended to be in the nature of words of description rather than of limitation. Many modifications and variations are possible in light of the above teachings and the invention may be practiced otherwise than as specifically described.

What is claimed is:

1. A curved arm apparatus for actuating a tool relative to a vehicle moving through a series of vertical beams set in two parallel lines forming a tunnel, the tunnel utilizing the series of vertical beams as a structure for a car washing system, the apparatus comprising:
an arm having a proximal end and a distal end, the arm comprising:
a curved portion at the proximal end, the curved portion being a structural member configured to extend around at least a portion of a vertical beam of the series of vertical beams, the curved portion having at least a partial arcuate profile and configured to attach to an exterior-facing side of the vertical beam;
a straight portion extending from the curved portion to the distal end, the straight portion being a structural member extending longitudinally from the curved portion and configured to connect to the tool;
a tool coupled to the distal end of the arm;
a mounting mechanism configured to mount the arm on the exterior-facing side of the vertical beam relative to the tunnel, such that the curved portion is extendable around the vertical beam; and
an actuator configured to move the arm between a first position wherein the tool is closer to the vertical beam and a second position wherein the tool projects into the tunnel.

2. A vehicle treatment apparatus for use in a tunnel defined by opposing sets of vertical beams, comprising:
an arm having a proximal end and a distal end;
the proximal end including a curved portion configured to extend at least partially around a vertical beam such that at least a portion of the arm is positioned on a side of the vertical beam opposite the tunnel;
a straight portion extending from the curved portion and configured to project into the tunnel;
a tool coupled to the distal end; and
an actuator configured to move the arm between:
(i) a retracted position in which the tool is positioned outside or adjacent to the vertical beam, and
(ii) an extended position in which the tool is positioned within the tunnel to engage a vehicle.

3. The apparatus of claim 2, wherein the curved portion has at least a partial arcuate profile configured to distribute load around the beam.

4. The apparatus of claim 2, wherein the arm is mounted entirely on an exterior-facing side of the beam.

5. The apparatus of claim 2, wherein the actuator includes a pivot located behind the beam relative to the tunnel.

6. The apparatus of claim 2, wherein the tool comprises a rotating brush.

7. The apparatus of claim 2, wherein the retracted position places the tool outside a maximum vehicle envelope.

8. The apparatus of claim 2, wherein the curved portion wraps around at least 90 degrees of the beam.

9. A vehicle wash system, comprising:
a first set of vertical beams and a second set of vertical beams defining a tunnel;
at least one arm mounted to a beam of the first set, the arm including a curved portion extending around the beam to position a mounting portion outside the tunnel;
a tool supported by the arm; and
an actuator configured to move the tool between a retracted position and an extended position within the tunnel;
wherein the arm functionally increases the usable width of the tunnel without increasing spacing between the sets of vertical beams.

10. The system of claim 9, further comprising a second arm mounted to an opposing beam and supporting the tool.

11. The system of claim 10, wherein the arms are synchronized.

12. The system of claim 9, wherein the arm is configured for retrofit installation on an existing carwash structure.

13. A method of operating a vehicle wash system, comprising:
mounting an arm to a vertical beam such that a portion of the arm is positioned outside a tunnel defined by the beams;
retracting a tool to a position adjacent to or behind the beam; and
extending the tool into the tunnel to engage a vehicle;
wherein the method increases usable operational width without modifying beam spacing.
